(19) United States
(12) Patent Application Publication
(10) Pub. No.: US 2025/0207618 A1
(43) Pub. Date: Jun. 26, 2025

(54) CLIP

(71) Applicant: NEWFREY LLC, New Britain, CT (US)

(72) Inventor: Shin KATAOKA, Utsunomiya-shi, Tochigi-ken (JP)

(21) Appl. No.: 18/990,657

(22) Filed: Dec. 20, 2024

(30) Foreign Application Priority Data
Dec. 26, 2023 (JP) 2023-219232

(51) Int. Cl. F16B 2/22; E05D 5/10

(52) U.S. Cl. CPC F16B 2/22; E05D 5/10

(57) ABSTRACT

A clip with improved stay retention comprises a clip body, a hinge connected to a hinge side of the clip body, and a lid rotatably connected to the clip body via the hinge can be opened and closed. The clip body includes a stay holding part defining a stay insertion hole with a stay locking claw. When the stay is inserted into the stay insertion hole, the stay locking claw locks the stay, The lid incudes a lid main body and a restricting part with a first restricting surface on the inside. The restricting part is connected to the hinge so that, when the lid main body is closed on the clip body, the first restricting surface abuts the stay holding part and presses the stay holding part toward the clip body and thereby restricts movement of the stay holding part in the direction tending to unlock the stay.

### CROSS-REFERENCE TO RELATED APPLICATIONS

This application claims priority from Japanese Patent Application No. 2023-219232, filed on Dec. 26, 2023, the entire disclosure of which is incorporated herein by reference.

### BACKGROUND OF THE PRESENT INVENTION

The present invention concerns a clip, specifically a stay-inserted clip.

Generally, when attaching and fixing a mounting member such as a

busbar to a mounting member such as an automobile body, the clip is inserted into a stay equipped on the automobile body and fixed in advance, and then the bus bar is attached to the clip and fixed. Clips for such purposes are provided, for example, as seen in Patent Document 1.

For such clips, if the clip's holding force against the stay is low, the clip may not be able to suppress the displacement of the busbar that occurs during a car crash, and it may come off. In such cases, it may be possible to increase the number of clips attached to each busbar. However, simply increasing the number of clips increases the number of parts and attachment points, which is undesirable from the standpoint of cost and installation labor. Therefore, there has been a demand for a clip that has improved holding force against the stay as a single clip.

Patent Document 1] Japanese Unexamined Patent Application Publication No. 2006-138445.

### SUMMARY OF THE INVENTION

In light of the above-described circumstances, the problem to be solved by the present invention is to provide a clip with improved retention of the stay.

The present invention has been developed to solve such problems; the clip in one embodiment of the present invention is a clip that is inserted into a stay and fixed, wherein the clip is equipped with a clip body, a hinge connected to a side of the clip body and a lid that is rotatably connected to the clip body via the hinge and can be opened and closed relative to the clip body via the hinge; the clip body is equipped with a stay holding part on the side of the clip body; the stay holding part holds the stay by inserting the stay into a stay insertion hole comprised in the stay holding part and engaging the stay with a stay locking claw equipped on the side of the stay insertion hole of the stay holding part; the lid comprises a lid main body and a restricting part extending vertically from the lid main body; the restricting part is connected to the hinge and has a first restricting surface on the inside of the restricting part; and when the lid main body is closed to the clip body, the first restricting surface abuts against the outer side of the stay holding part, and the stay holding part is pressed toward the inside of the clip body to restrict the movement of the stay holding part in a first direction in which the engagement between the stay locking claw and the stay is released.

In another embodiment of the clip, the stay holding part is further equipped with a first protrusion on an upper side surface of the stay holding part, the restricting part further comprises a second restricting surface perpendicular to the first restricting surface and facing the lid body part, and when the lid body part is closed to the clip body, the second restricting surface abuts the lower surface of the first protrusion and presses the first protrusion toward the upper surface, thereby restricting movement of the stay holding part in the second direction, which is the direction in which the stay falls off.

In another embodiment, the clip may be configured such that the lid body is further equipped with a third regulating surface on the inside of the lid body, and when the lid body is closed to the clip body, the third regulating surface abuts the clip body and presses in the first direction, via the clip body, and the surface of the stay holding part opposite the surface is pressed by the first regulating surface, thereby regulating the movement of the first regulating surface in the first direction and regulating the movement of the stay holding part in the first direction.

In another embodiment, the clip may be configured such that the lid body is further equipped with a fourth regulating surface on the inside of the lid body, and when the lid body is closed to the clip body, the fourth regulating surface abuts the clip body and presses in the second direction, via the clip body, the upper surface of the stay holding part opposite the lower surface of the first protrusion part against which the second regulating surface presses, thereby regulating the movement of the second regulating surface in the second direction and regulating the movement of the stay holding part in the second direction.

The clip of the present invention can provide a clip with improved stay retention.

### BRIEF DESCRIPTION OF THE DRAWINGS

FIG. 1 is a perspective view of the clip from above with the lid open.

FIG. 2 is a cross-sectional view taken along line A-A in FIG. 1.

FIG. 3 is a perspective view of the clip from below with the lid open.

FIG. 4 is a view showing how a bus bar is attached to a clip fixed to a stay.

FIG. 5 is a perspective view of the clip with the lid closed.

FIG. 6 is a cross-sectional view taken along line B-B in FIG. 5.

### DESCRIPTION OF THE PREFERRED EMBODIMENTS

The clip according to the embodiment of the present invention will be described below with reference to the drawings.

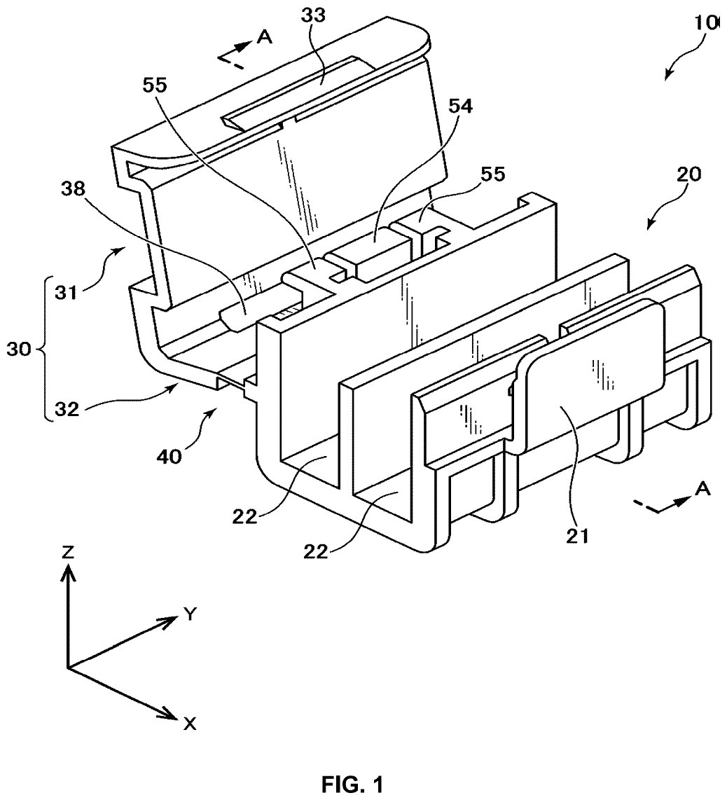

FIG. 1 shows a perspective view of a clip 10 with the lid 30 of an embodiment of the present invention open, viewed from above. The clip 10 is made of, for example, resin. The clip 10 comprises a clip body 20, a lid 30 and a hinge 40. The hinge 40 is connected to a side surface of the clip body 20. In the present embodiment, the hinge 40 is connected to a side surface of the clip body 20 parallel to the YZ plane. The lid 30 comprises a lid body part 31 and a restricting part 32. The restricting part 32 extends in the X-axis direction, which is perpendicular to the lid body part 31. The clip body 20 and the restricting part 32 of the lid 30 are rotatably connected by the hinge 40. The lid 30 can be opened and closed relative to the clip body 20 by rotating via the hinge 40.

The clip body 20 is configured to hold a busbar 61, which will be described later in the description of FIG. 5. In the present embodiment, the clip body 20 has two receiving parts 22 so that it can hold two busbars 61. The clip body 20 is equipped with a lid locking claw receiver 21. In the present embodiment, the lid locking claw receiver 21 comprises a protrusion. The lid main body 31 has a lid locking claw 33. In the present embodiment, the lid locking claw 33 comprises a protrusion. As will be described later, in the present embodiment, when the lid 30 rotates relative to the clip body 20 via the hinge 40 and the lid main body 31 is closed relative to the clip body 20, the protrusion of the lid locking claw 33 and the protrusion of the lid locking claw receiver 21 engage with each other, and the lid locking claw 33 and the lid locking claw receiver 21 engage with each other, so that the lid main body 31 is held in a closed state relative to the clip body 20.

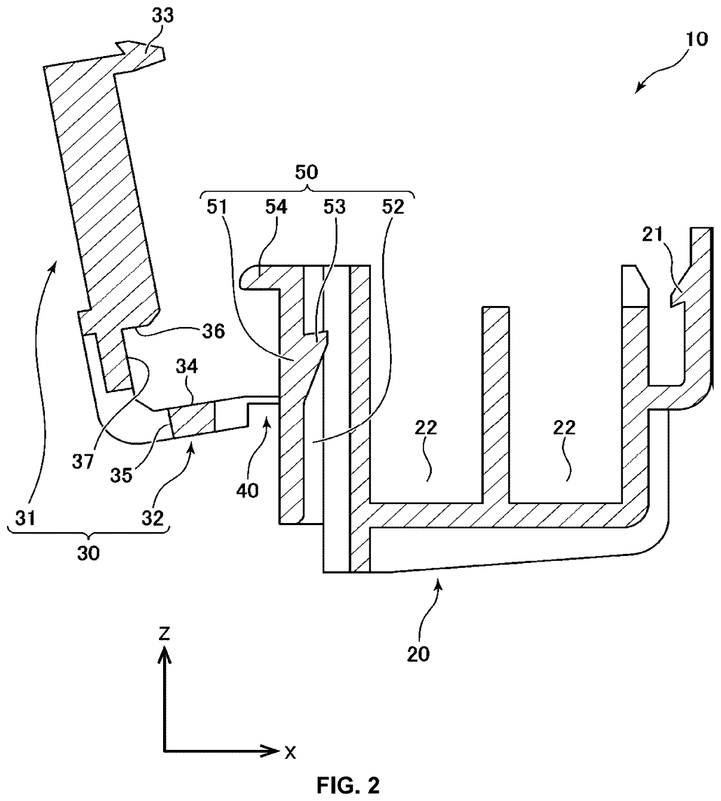

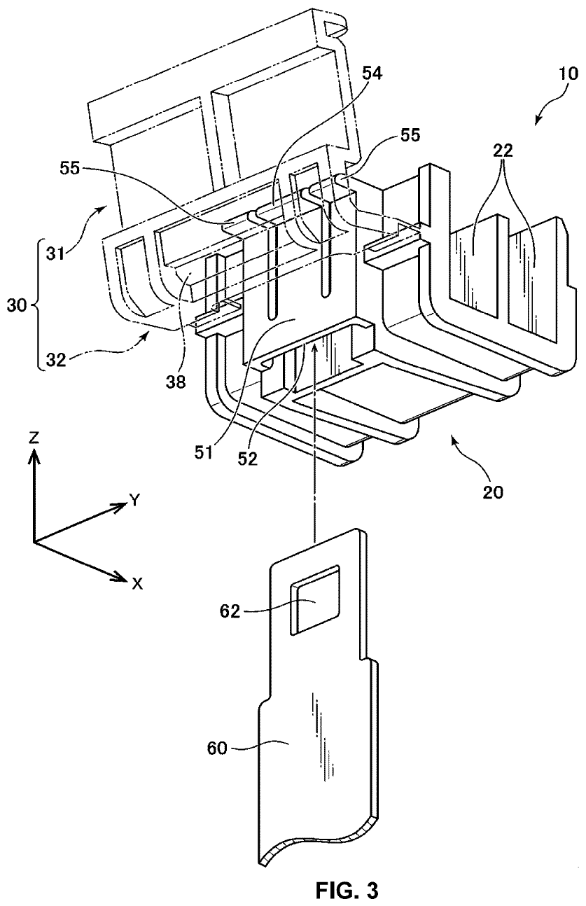

FIG. 2 shows a cross-sectional view taken along line A-A in FIG. 1. The clip body 20 is equipped with a stay holding part 50 on its side surface. In the present embodiment, the stay holding part 50 is provided on the side surface of the clip body 20 parallel to the YZ plane. The stay holding part 50 is equipped with a stay holding piece 51, a stay insertion hole 52, a stay locking claw 53, a first protrusion 54, and a second protrusion 55. The first protrusion 54 is provided on the upper side surface of the stay holding part 50 and extends in the −X direction, which is perpendicular to the stay holding piece 51. The stay insertion hole 52 can be under-stood to be comprised inside the stay holding part 50 by referring to FIG. 3 and other figures. The stay locking claw 53 is provided on the side of the stay insertion hole 52, and in the present embodiment, the stay locking claw 53 is provided on the side of the stay insertion hole 52 on the stay holding piece 51 side.

As will be described later in the explanation of FIG. 3, the stay 60 is inserted into the stay insertion hole 52 comprised in the stay holding part 50. The second protrusion 55, like the first protrusion 54, is provided on the upper side surface of the stay holding part 50 and extends in the −X direction perpendicular to the stay holding piece 51. In the present embodiment, by referring to FIG. 3 and other figures, it can be understood that two second protrusions 55 are provided on the upper side surface of the stay holding part 50 and extend in the −X direction perpendicular to the stay holding piece 51.

The regulating part 32 of the lid 30 is equipped with a first regulating surface 34 on the inside of the regulating part 32. The regulating part 32 is also equipped with a second regulating surface 35 that is perpendicular to the first regulating surface 34 and faces the lid main body part 31. The lid main body part 31 of the lid 30 is equipped with a third regulating surface 36 on the inside of the lid main body part 31. The fourth restricting surface 37 is provided at a position perpendicular to the third restricting surface 36.

FIG. 3 shows a perspective view of the clip 10 with the lid 30 of the embodiment of the present invention open, viewed from below. The lid 30 comprises a hole 38 between the lid body 31 and the restricting part 32. As shown by the dashed line, the stay 60 is inserted into the stay insertion hole 52 in the Z-axis direction. In the present embodiment, when the stay 60 is inserted into the stay insertion hole 52, the stay locking claw 53 engages with the hole 62 provided in the stay 60, thereby locking the stay 60. In this way, the stay 60 is locked by the stay locking claw 53, and the stay 60 is held in the stay holding part 50.

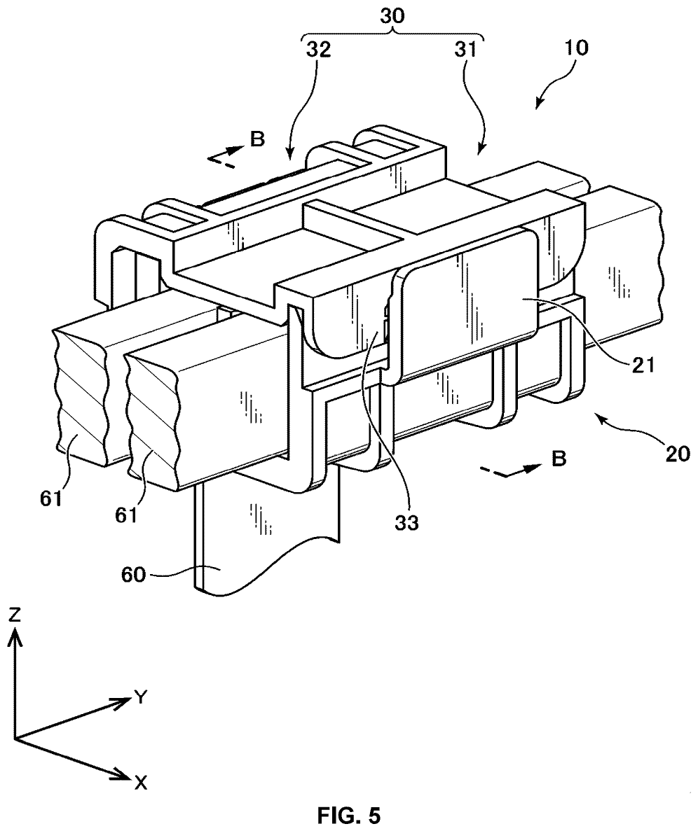

FIG. 4 shows how the bus bar 61 is attached to the clip 10 fixed to the stay 60 in an embodiment of the present invention. As shown by the dashed line, the bus bar 61 can be held in the clip 10 by placing it in the receiving part 22 of the clip body 20 of the clip 10.

FIG. 5 shows a state in which the bus bar 61 is attached to the clip 10 and the lid body 31 is closed relative to the clip body 20 in an embodiment of the present invention. After the bus bar 61 is installed in the receiving part 22 of the clip body 20 of the clip 10, the lid body 31 is closed relative to the clip body 20. At this time, the protrusion of the lid locking claw 33 of the lid body 31 and the protrusion of the lid locking claw receiver 21 of the clip body 20 engage with each other, and the lid locking claw 33 and the lid locking claw receiver 21 are locked together, so that the lid body 31 is held in a closed state relative to the clip body 20, and the clip 10 continues to hold the bus bar 61 from the state shown in FIG. 4.

When the lid body 31 is closed on the clip body 20 as shown in FIG. 5, the first protrusion 54 and the second protrusion 55 of the stay holding part 50 abut the hole 38 of the lid 30. In the present embodiment, the second protrusion 55 is provided at two locations, and both of the second protrusions 55 abut the hole 38 of the lid 30. The hole 38 of the lid 30 is provided so that the lid 30 does not interfere with the first protrusion 54 and the second protrusion 55 when the lid body 31 is closed, but a configuration other than the hole 38 may be used as long as the lid 30 does not interfere with the first protrusion 54 and the second protrusion 55.

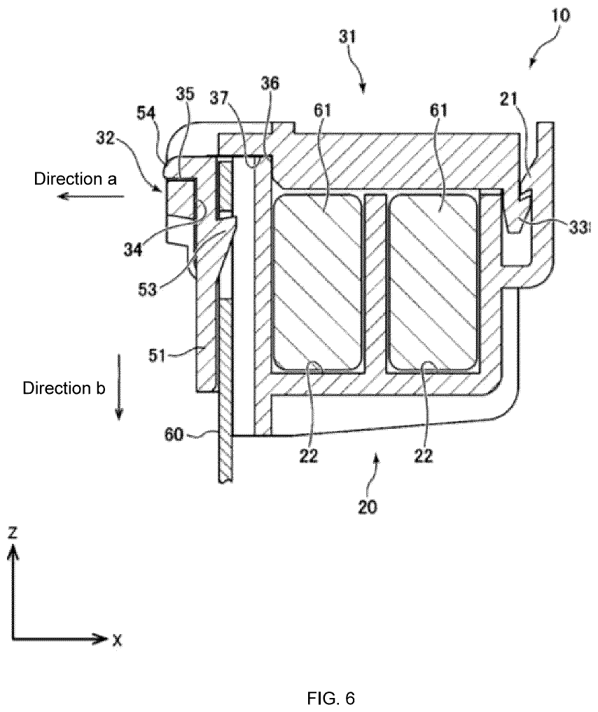

FIG. 6 shows a cross-sectional view taken along line B-B in FIG. 5. The first restricting surface 34 abuts the outer side of the stay retaining piece 51 of the stay retaining part 50 and presses the stay retaining part 50 in the +X direction, which is the direction toward the inside of the clip body 20. In this way, the first restricting surface 34 presses the stay retaining part 50, thereby restricting the movement of the stay retaining part 50 in direction a, which is the direction in which the engagement between the stay locking claw 53 and the stay 60 is released. By restricting the movement of the stay retaining part 50 in this way, the holding force of the stay retaining part 50 for the stay 60 is improved, and thus the holding force of the stay 60 of the clip 10 is improved.

The second restricting surface 35 also abuts the underside of the first protrusion 54 and presses the first protrusion 54 in the +Z direction, which is the direction toward the upper surface of the first protrusion 54. In this way, the second restricting surface 35 presses the first protrusion 54, thereby restricting movement of the stay holding part 50 in direction b, which is the direction in which the stay 60 falls off. By restricting the movement of the stay holding part 50 in this way, the holding force of the stay 60 of the stay holding part 50 is improved, and ultimately the holding force of the stay 60 of the clip 10 is improved.

The third restricting surface 36 abuts the clip body 20 and presses the inner side of the stay holding piece 51 of the stay holding part 50, which is opposite the outer side pressed by the first restricting surface 34 in direction a, which is the direction in which the stay locking claw 53 and the stay 60 are released via the clip body 20, thereby restricting the movement of the first restricting surface 34 in direction a and restricting the movement of the stay holding part 50 in direction a. By restricting the movement of the stay holding part 50 in this way, the holding force of the stay 60 of the stay holding part 50 is improved, and ultimately the holding force of the stay 60 of the clip 10 is improved.

The fourth restricting surface 37 abuts the clip body 20 and presses the upper surface of the stay holding part 50, opposite the lower surface of the first protrusion 54 pressed by the second restricting surface 35, in direction b, the direction in which the stay 60 falls off, via the clip body 20, thereby restricting the movement of the second restricting surface 35 in the second direction, the direction in which the stay 60 falls off, and restricting the movement of the stay holding part 50 in the second direction. By restricting the movement of the stay holding part 50 in this way, the holding force of the stay holding part 50 for the stay 60 is improved, and ultimately the holding force of the stay 60 for the clip 10 is improved.

Here, the action and effect of the first restricting surface 34, the second restricting surface 35, the third restricting surface 36 and the fourth restricting surface 37 as described above occurs when the lid body part 31 is closed on the clip body 20, and the first restricting surface 34, the second restricting surface 35, the third restricting surface 36 and the fourth restricting surface 37 restrict the movement of the stay holding part 50, and by restricting the movement of the stay holding part 50 in this manner, the holding force of the stay 60 of the stay holding part 50 is improved, and ultimately the holding force of the stay 60 of the clip 10 is improved.

In addition, when the cover body 31 is open relative to the clip body 20, the action and effect of the first restricting surface 34, the second restricting surface 35, the third restricting surface 36 and the fourth restricting surface 37 as described above do not occur, so the load applied when inserting the stay 60 into the stay insertion hole 52 is not large compared to a conventional clip that does not have the first restricting surface 34, the second restricting surface 35, the third restricting surface 36 and the fourth restricting surface 37, and the clip 10 can be attached to the stay 60 with a force of about the same magnitude as in the case of such a conventional clip.

In the embodiment of the clip 10 having all of the first restricting surface 34, the second restricting surface 35, the third restricting surface 36 and the fourth restricting surface 37 described above, the movement of the stay holding part 50 in the four directions, i.e., direction a and the opposite direction, and direction b and the opposite direction, is restricted. By restricting the movement of the stay holding part 50 in this way, the holding force of the stay 60 of the stay holding part 50 is further improved, and, in turn, the holding force of the stay 60 of the clip 10 is further improved.

The above describes an embodiment of the present invention with reference to the drawings; however, the clip is not limited to the specific structure described and can be modified as appropriate, as long as it is configured to be held by the stay.

Although the present invention has been described by way of example, application of the present invention is not limited to, for example, automobiles; it can be applied to various products and can be appropriately applied within the scope of the technical idea of the invention.

Description of Reference Numerals: 10 Clip, 20 Clip body, 21 Lid locking claw receiver, 22 Receptacle, 30 Lid, 31 Lid body, 32 Restriction part, 33 Lid locking claw, 34 First restricting surface, 35 Second restricting surface, 36 Third restricting surface, 37 Fourth restricting surface, 38 Hole, 40 Hinge, 50 Stay holding part, 51 Stay holding piece, 52 Stay insertion hole, 53 Stay locking claw, 54 First protrusion, 55 Second protrusion, 60 Stay, 61 Bus bar, 62 Hole.

What is claimed is:

1. A clip fixable to a stay, the clip comprising:
a clip body;
a hinge connected to a hinge side of the clip body;
a lid that is rotatably connected to the clip body via the hinge and the lid can be opened and closed relative to the clip body via the hinge;
a stay holding part partially defining a stay insertion hole located on the hinge side of the clip body, and the stay holding part holds the stay by receiving the stay into the stay insertion hole and engaging the stay with a stay locking claw located on an inside of the stay insertion hole; and
the lid comprises a lid main body and a restricting part extending at a right angle from the lid main body, and the restricting part is connected to the hinge; and the restricting part includes a first restricting surface on the inside of the restricting part; and
when the lid main body is closed to the clip body, the first restricting surface abuts an outer side of the stay holding part, and the stay holding part is pressed toward the clip body to restrict movement of the stay holding part in a first direction away from the clip body and in which first direction the engagement between the stay locking claw and the stay is released.

2. The clip according to claim 1, wherein:
the stay holding part further comprises a first protrusion on an upper side surface of the stay holding part;
the restricting part further comprises a second restricting surface that is perpendicular to the first restricting surface and faces the lid main body part; and
when the lid main body part is closed to the clip body, the second restricting surface abuts a lower surface of the first protrusion and presses the first protrusion toward the upper surface side and thereby restricts movement of the stay holding part in a second direction perpendicular to the first direction and in which second direction the stay falls off.

3. The clip according to claim 2, wherein the lid body further includes a third restricting surface located on an inside of the lid body, and the third restricting surface parallel to the first restricting surface; and
when the lid body is closed to the clip body, the third restricting surface abuts the clip body and via the clip body presses a surface of the stay holding part in the first direction toward the first restricting surface and thereby restricts movement of the first restricting surface opposite to the first direction and restricts movement of the stay holding part in the first direction.

4. The clip according to claim 3, wherein the lid body further includes a fourth restricting surface located on the inside of the lid body, and the fourth restricting surface is perpendicular to the third restricting surface, and
when the lid body is closed to the clip body, the fourth restricting surface abuts the clip body and presses in the second direction an upper surface of the stay holding part, which upper surface is opposite to the lower surface of the first protrusion, and thereby restricts movement of the second restricting surface opposite to the second direction and restricts movement of the stay holding part in the second direction.
